(19) United States
(12) Patent Application Publication
(10) Pub. No.: US 2011/0248096 A1
(43) Pub. Date: Oct. 13, 2011

(54) NEBULIZING APPARATUS

(75) Inventors: CHIEN-HUA LIN, TAOYUAN COUNTY (TW); CHIA-CHEN HUANG, TAOYUAN COUNTY (TW); LIANG-WEI LIU, TAOYUAN COUNTY (TW); TAI-SHUAN LIN, TAOYUAN COUNTY (TW); YU-CHUNG HSU, TAIPEI (TW); CHIEH-MING HSIUNG, TAOYUAN COUNTY (TW); MEI-HUI HUANG, TAOYUAN COUNTY (TW)

(73) Assignee: MICRO BASE TECHNOLOGY CORPORATION, TAOYUAN COUNTY (TW)

(21) Appl. No.: 13/018,957

(22) Filed: Feb. 1, 2011

(30) Foreign Application Priority Data
Apr. 7, 2010 (TW) 099206120

(51) Int. Cl. B05B 1/08

(52) U.S. Cl. 239/102.2; 239/102.1

(57) ABSTRACT

The present invention discloses a nebulizing apparatus comprising an outer housing, a reservoir, a nebulizing unit, a chassis, a control unit and a power supply unit. The reservoir is disposed in the accommodation space of the outer housing and provided for storing a solution. The nebulizing unit is disposed in the reservoir for nebulizing the solution stored in the reservoir to generate a plurality of nebulized particles. The chassis is disposed between the reservoir and the outer housing. The control unit is disposed on the chassis and electrically connected to the nebulizing unit for controlling the vibration frequency required by the nebulizing unit to nebulize the solution. The power supply unit is disposed on the chassis and connected with the control unit, and provides the required power and electronic signals to the nebulizing unit through the control unit.

### FIELD OF THE INVENTION

The present invention relates to a nebulizing apparatus, and more particularly to a nebulizing apparatus for nebulizing a solution into nebulized particles.

### BACKGROUND OF THE INVENTION

At present, conventional nebulizing apparatuses use the vibration principle to convert a liquid into a mist to float in the air. Liquid molecules are incorporated into the air due to the effect of Brownian movement, so as to change properties of the air. Such apparatuses are widely applied in drug or fragrance dispersing apparatuses, or applied to countries in drier regions for the purpose of indoor humidification.

However, a nebulizing apparatus conventionally used for changing properties of the air has no function of circulating and recycling water. When the nebulizing apparatus is in use, water drops are often condensed at the outlet of the nebulizing apparatus for spraying nebulized particles. After these water drops are accumulated to a certain extent, they flow to the location (e.g. a tabletop), at which the nebulizing apparatus is placed, along the surface of the nebulizing apparatus to wet the surroundings or to blur the peripheral articles, such as a tablecloth, garments, etc.

Moreover, traditional nebulizing apparatuses with submerged ultrasonic vibrators must consume a relatively large amount of power to generate water mists. Batteries or other power supply means for providing low currents (e.g. USB power lines using a 5 volt direct current) cannot be used to supply power thereto, which in turn results in inconvenience of carrying.

### SUMMARY OF THE INVENTION

In view of the above-mentioned problems of the prior art, an object of the present invention is to provide a nebulizing apparatus for preventing the nebulized particles from wetting the periphery of the nebulizing apparatus or from blurring the articles around the nebulizing apparatus.

According to the object of the present invention, there is provided a nebulizing apparatus comprising a reservoir, an outer housing, a nebulizing unit, a chassis, a fan, a control unit and a power supply unit. The outer housing includes an accommodation space. The reservoir is disposed in the accommodation space and provided for storing a solution. The nebulizing unit is disposed in the reservoir at the position adjacent to the top of the reservoir for nebulizing the liquid stored in the reservoir to generate nebulized particles from the solution. The chassis is disposed between the reservoir and the outer housing. The fan is disposed on the chassis for blowing the nebulized particles outside of the outer housing. The control unit is disposed on the chassis and connected to the nebulizing unit and the fan. The power supply unit is disposed on the chassis and connected with the control unit, and provides the required power to the nebulizing unit and the fan through the control unit.

The reservoir comprises an outer cup, an inner cup, a first filtering unit and a driving unit. The outer cup is disposed in the accommodation space. The inner cup is disposed in the outer cup. The first filtering unit is disposed on the bottom of the inner cup. The driving unit is disposed on the bottom of the outer cup. The driving unit is used for actively driving the solution in the outer cup into the nebulizing unit. The inner cup and the outer cup communicate with each other. A condensed liquid returns to the inner cup in the reservoir along the inner side of the first cover, and then flows into the outer cup after the impurities are filtered by the first filtering unit. Finally, the driving unit drives the solution in the outer cup into the nebulizing unit for nebulizing the solution.

The nebulizing unit comprises a fixed base, a liquid conduit and a nebulizing module. The fixed base is disposed between the inner cup and the outer cup and connected to the inner cup. One end of the liquid conduit is disposed on one side of the fixed base, and the other end of the liquid conduit is connected with the driving unit. The liquid conduit is used for transmitting the solution pumped by the driving unit from the outer cup. The nebulizing module is disposed on the fixed base at the position adjacent to the liquid conduit. The solution pumped by the driving unit from the outer cup forms a curved liquid film in the gap between the driving unit and the nebulizing unit. The curved liquid film is attached to the nebulizing unit.

The nebulizing module comprises a piezoelectric drive element and a nebulizing plate. The piezoelectric drive element is disposed on the fixed base. The nebulizing plate has a plurality of millipores and is connected with the piezoelectric drive element. The nebulizing plate is disposed on the fixed base and spaced apart from the liquid conduit at an interval. The curved liquid film is attached to a surface of the nebulizing unit. The piezoelectric drive element facilitates the vibration of the nebulizing plate, so that the plurality of millipores of the nebulizing plate nebulize the curved liquid film to generate the nebulized particles.

As described above, the nebulizing apparatus of the present invention may have one or more of the following advantages:

(1) The driving unit of the liquid recovery mechanism of the nebulizing apparatus of the present invention is an active driving unit that can actively supply a solution to the nebulizing unit. Besides, the nebulizing apparatus has an external power unit, so it consumes much less energy than nebulizing apparatuses in other forms and provides great carrying convenience.

(2) Compared with a conventional nebulizing apparatus, the nebulizing apparatus of the present invention can save energy in recovering condensed solution.

(3) The nebulizing apparatus of the present invention has a control unit provided for regulating the atomization frequency.

(4) The configuration of the liquid recovery mechanism of the nebulizing apparatus of the present invention is designed to completely recover condensed liquid so as to avoid wetting of the location where the nebulizing apparatus exists.

(5) The first cover of the nebulizing apparatus of the present invention can also shield against nebulized particles of larger diameters, so that such nebulized particles are attached to the first cover and can be recovered and nebulized, and so that nebulized particles of smaller diameters can be released out. Hence, the nebulizing apparatus provides the function of screening nebulized particles by particle diameter, and can enhance diffusion in conjunction with the fan.

### BRIEF DESCRIPTION OF THE DRAWINGS

FIG. 1 is a schematic view showing a construction of a nebulizing apparatus according to the present invention;

FIG. 2 is an exploded schematic view showing the structure of a nebulizing apparatus according to the present invention;

FIG. 3 is a schematic view showing the appearance of a nebulizing apparatus according to the present invention;

FIG. 4 is a cross-sectional schematic view of a nebulizing apparatus according to the present invention; and

FIG. 5 is a cross-sectional schematic view of a nebulizing module according to the present invention.

### DETAILED DESCRIPTION OF THE PREFERRED EMBODIMENTS

Hereinafter, embodiments of the nebulizing apparatus according to the present invention will be described with reference to the related drawings. For the convenience of understanding the description, the same elements in the embodiments will be given the same reference numerals.

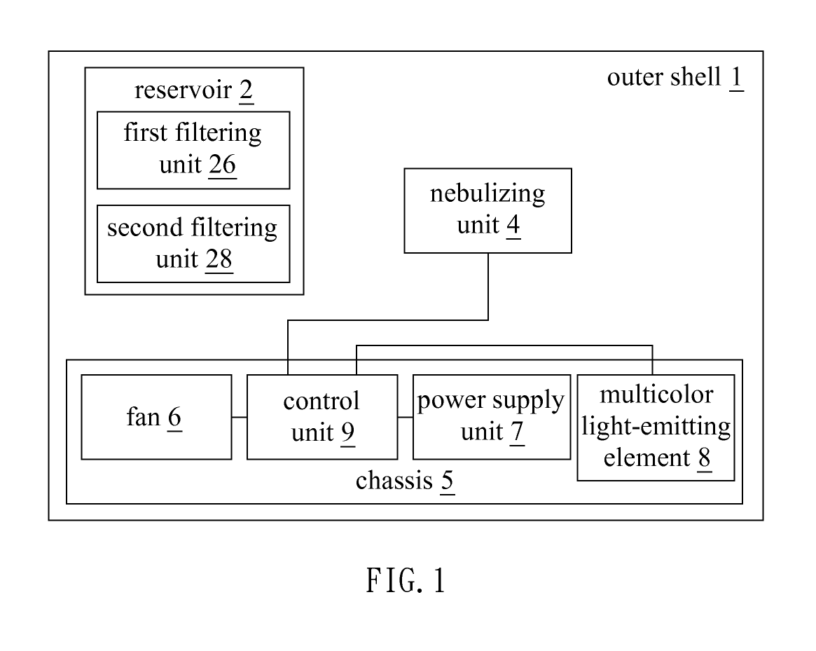

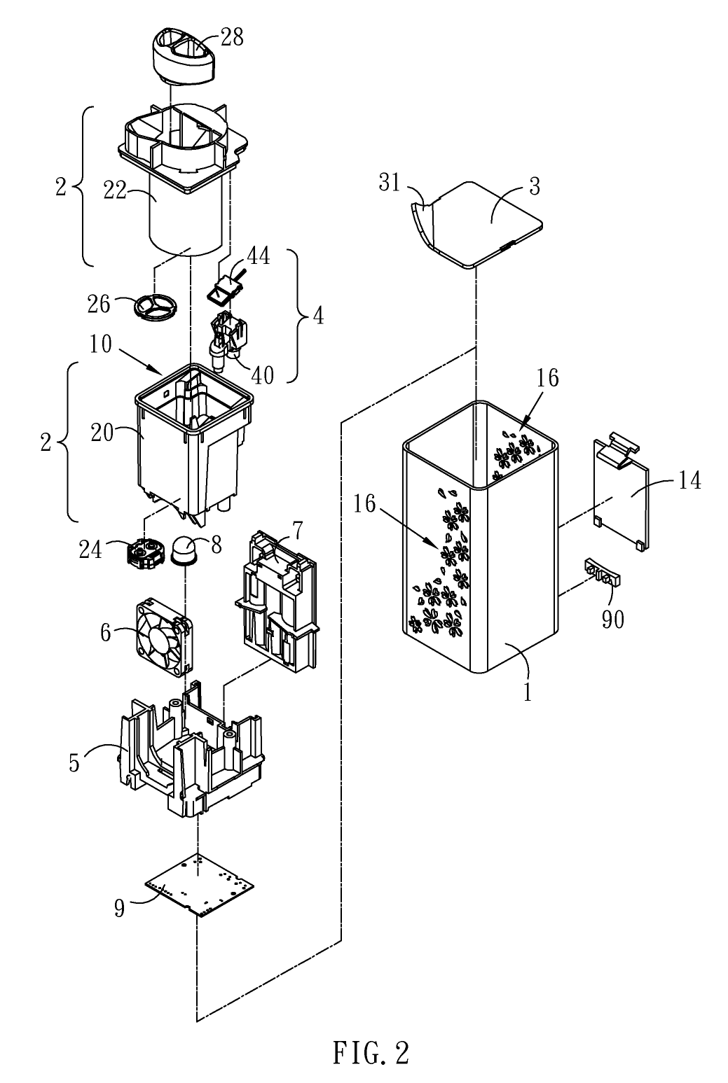

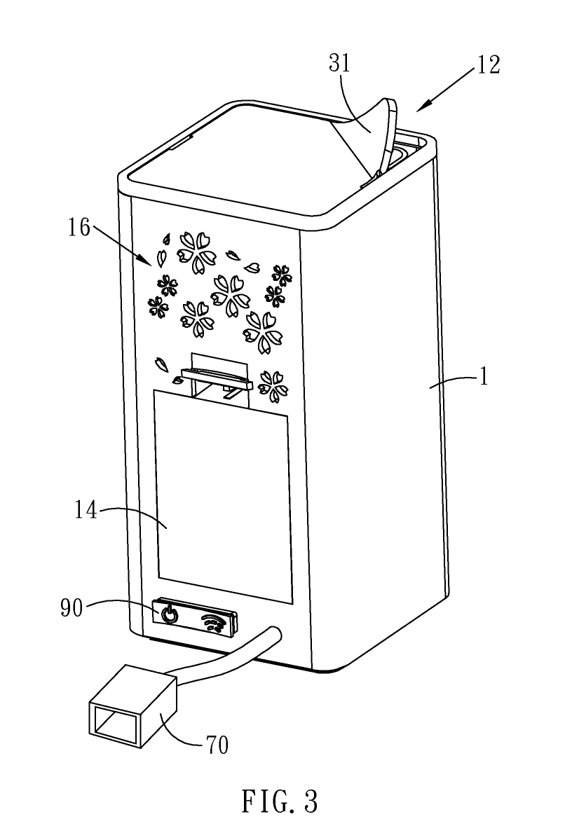

Referring to FIGS. 1 and 2, there are shown a schematic view showing a construction of and an exploded schematic view of a nebulizing apparatus according to the present invention. In these figures, the nebulizing apparatus comprises an outer housing 1 made of plastic or metal, a reservoir 2, a first cover 3, and a nebulizing unit 4. The outer housing 1 includes an accommodation space 10. The reservoir 2 is disposed in the accommodation space 10 and provided for storing a solution. The nebulizing unit 4 is disposed in the reservoir 2 at the position adjacent to the top of the reservoir 2 for nebulizing the solution stored in the reservoir 2 to generate a plurality of nebulized particles from the solution. The first cover 3 has a corner 31 that tilts upward. When the first cover 3 is closed on the outer housing 1, the corner 31 and the first cover 3 form an opening 12 (as shown in FIG. 3) to allow the nebulized particles to be dispersed outside of the outer housing 1. Furthermore, a condensed liquid formed by condensing the nebulized particles on the first cover 3 can flow back to the reservoir 2 along the inner side of the first cover 3.

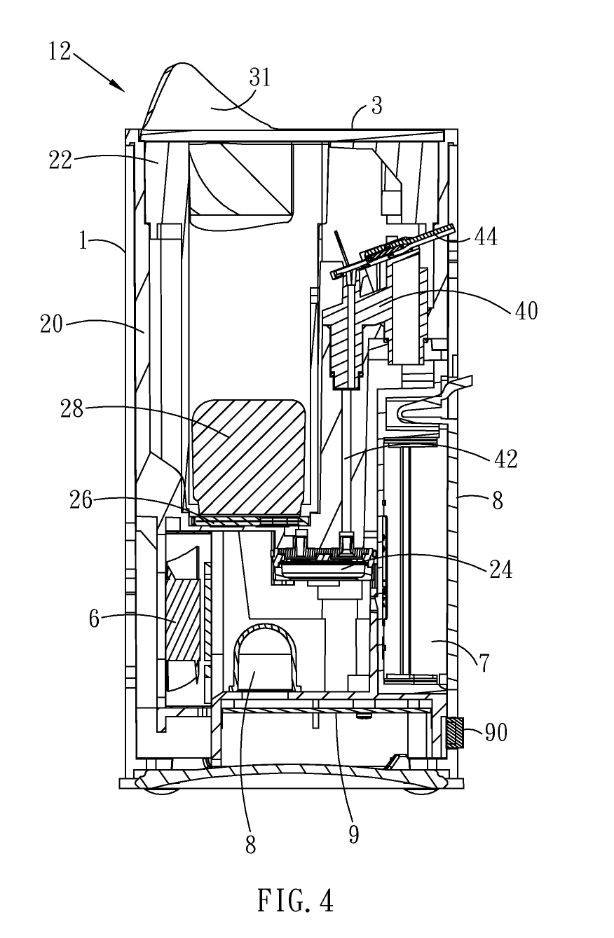

Referring to FIG. 4, there is shown a cross-sectional schematic view of a nebulizing apparatus according to the present invention. In this figure, the reservoir 2 comprises an outer cup 20 made of plastic or metal, an inner cup 22 made of plastic or metal, a driving unit 24 and a first filtering unit 26. The outer cup 20 is disposed in the accommodation space 10. The inner cup 22 is disposed in the outer cup 20. The inner cup 22 and the outer cup 20 are designed to communicate with each other. The first filtering unit 26 is disposed on the bottom of the inner cup 22. The driving unit 24 is disposed on the bottom of the outer cup 20.

According to the above description, the driving unit 24 drives the solution in the outer cup 20 into the nebulizing unit 4, and the nebulizing unit 4 nebulizes the solution transported from the reservoir 2. Furthermore, a condensed liquid formed by condensing the nebulized particles on the first cover 3 can be recovered to the inner cup 22 along the inner side of the first cover 3, and then flows into the outer cup 20 after filtered by the first filtering unit 26. In this way, the above-mentioned steps can be repeated in a cycle to achieve the purpose of avoiding wetting of the periphery of the nebulizing apparatus or blurring of the articles around the nebulizing apparatus.

The first filtering unit 26 may be any substance capable of filtering impurities, such as a filter screen, porphyries andesite, a filter cartridge, a carbon filter layer or an organic foam. A second filtering unit 28 may be optionally added to the bottom of the inner cup 22. Similarly, the second filtering unit 28 may be made of a replaceable filtering material, for example, any substance capable of filtering impurities, such as a filter screen, porphyries andesite, a filter cartridge, a carbon filter layer or an organic foam. If the first filtering unit 24 or the second filtering unit 28 is of an organic foam and the solution is essential oil, the nebulizing apparatus of the present invention has a function of diffusing aroma. Also, the driving unit 24 may be any equipment or component capable of causing the solution to move, such as a pump, a capillary transfer line, etc. The materials of the inner cup 22 and the outer cup 20 are one selected from any corresponding suitable plastics, metals, alloys or composite materials, or a combination thereof.

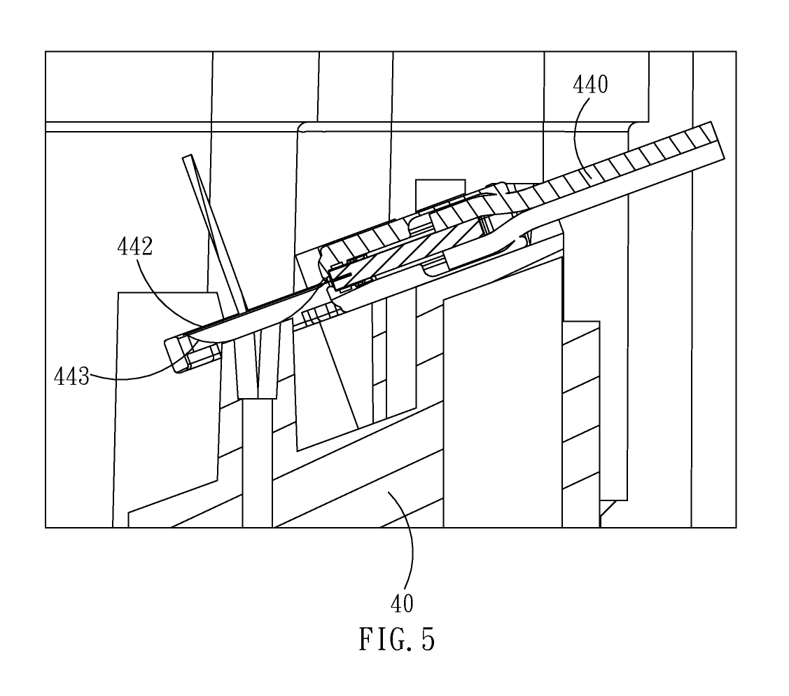

Referring to FIG. 2, the nebulizing unit 4 comprises a fixed base 40, a liquid conduit 42 and a nebulizing module 44. The fixed base 40 is disposed between the inner cup 22 and the outer cup 20. One end of the liquid conduit 42 is disposed on one side of the fixed base 40, and the other end of the liquid conduit 42 is connected with the driving unit 24. The liquid conduit 42 is used for transmitting the solution pumped by the driving unit 24 from the outer cup 20. The nebulizing module 44 is disposed on the fixed base 40 at the position adjacent to the liquid conduit 42. The solution pumped by the driving unit 24 from the outer cup 20 forms a curved liquid film 443 in the gap between the driving unit 24 and the nebulizing module 44. The curved liquid film 443 (referring to FIG. 5) is attached to the nebulizing unit 4.

Referring to FIG. 5, there is shown a schematic view of a nebulizing module according to the present invention. The nebulizing module 44 comprises a piezoelectric drive element 440 and a nebulizing plate 442. The piezoelectric drive element 440 is disposed on the fixed base 40. The nebulizing plate 442 is connected with the piezoelectric drive element 440, disposed on the fixed base 40 and spaced apart from the liquid conduit 42 at an interval. The interval is arranged so that the solution transmitted from the liquid conduit 42 to the nebulizing plate 442 forms a curved liquid film 443 in the interval. The nebulizing plate 442 has a plurality of millipores (not shown). When the nebulizing plate 442 is driven by the piezoelectric drive element 440, it is caused to vibrate and can nebulize the curved liquid film 443 to generate the nebulized particles.

Referring to FIG. 2, the nebulizing apparatus of the present invention further comprises a chassis 5 disposed between the bottom of the outer cup 20 and the bottom of the outer housing 1. The chassis 5 is used for bearing a fan 6, a power supply unit 7 and a multicolor light-emitting element 8. The power supply unit 7 is connected with the control unit 9 disposed on the bottom of the chassis 5. The control unit 9 is connected with the piezoelectric drive element 440 (referring to FIG. 5), the fan 6, an external power unit 70 and the multicolor light-emitting element 8. The control unit 9 is further connected to a control switch 90 (referring to FIG. 3). Moreover, a second cover 14 is disposed on the surface of the outer housing 1 at the position corresponding to the power supply unit 7. When the second cover 14 is removed from the outer housing 1, the power supply unit 7 exactly faces the outside.

Furthermore, the power supply unit 7 and the external power unit 70 are respectively used for providing the power required for actuation of the control unit 9, the fan 6 and the multicolor light-emitting element 8. The control unit 9 can control the vibration frequency of or the mode of intermittent actuation of the piezoelectric drive element 440, the luminous states of the multicolor light-emitting element 8 corresponding to the states of the nebulizing apparatus, and the rotational speed of the fan 6. The control switch 90 allows the user to regulate the vibration frequency of the piezoelectric drive element 440 and the rotational speed of the fan 6.

Also, the control unit 9 controls the color variation or the flickering state of the multicolor light-emitting element 8, so that the user can know the current operation state of the nebulizing apparatus. For example, when the vibration frequency of or the mode of intermittent actuation of the piezoelectric drive element 440 increases, the multicolor light-emitting element 8 displays one color. When the vibration frequency of or the mode of intermittent actuation of the piezoelectric drive element 440 decreases, the multicolor light-emitting element 8 displays another color. Furthermore, the multicolor light-emitting element 8 indicates an insufficient level of the solution in the reservoir or failure with yet another color or flickering state. Namely, light of different colors and flickering states emitted by the multicolor light-emitting element 8 can indicate different modes of operation or failure.

In addition, the power supply unit 7 may be a battery case or a charger. Thus, when the second cover 14 is removed from the outer housing 1, it is convenient to replace the battery case or a battery in the charger. The external power unit 70 (referring to FIG. 3) may be a DC power line (e.g. a 5 volt direct current supplied by a USB transmission line), or a 110 to 240 volt AC power line, or a power line for AC-to-DC conversion (for example, an 110 volt alternating current is converted into a 5 volt direct current through a transformer), or a power line connectable to a standard domestic socket. The multicolor light-emitting element 8 may be a plurality of light bulbs of different colors, or a plurality of LED lamps of different colors, or any current light-emitting component having various color variations.

Moreover, the surface of the outer housing 1 is provided with a plurality of hollowed out holes 16. The hollowed out holes 16 may be arranged in the form of cherry blossoms, stars, diamonds, etc. The fan 6 intakes the gas outside of the outer housing 1 through the hollowed out holes 16 of the outer housing 1 into the outer housing 1, and blows the nebulized particles through the opening 12 to the outside of the outer housing 1 in conjunction with the space within the outer housing 1 formed by the other assemblies. If not in use, the first cover 3 can be inversely covered and accommodated for convenient carrying. The solution used in the nebulizing apparatus may be water, a drug solution, aromatic essential oil, or the like, or a mixed solution thereof.

The above description is illustrative only and is not to be considered limiting. Various modifications or changes can be made without departing from the spirit and scope of the invention. All such equivalent modifications and changes shall be included within the scope of the appended claims.

What is claimed is:

1. A nebulizing apparatus comprising:
an outer housing having an accommodation space;
a reservoir disposed in the accommodation space and provided for storing a solution;
a nebulizing unit disposed in the accommodation space at the position adjacent to the reservoir for nebulizing the solution stored in the reservoir to generate a plurality of nebulized particles;
a chassis disposed between the reservoir and the outer housing;
a fan disposed on the chassis for blowing the nebulized particles outside of the outer housing;
a control unit disposed on the chassis and connected to the nebulizing unit and the fan for controlling the vibration frequency required by the nebulizing unit to nebulize the solution and the rotational speed of the fan; and
a power supply unit disposed on the chassis, connected with the control unit, providing the required power to the nebulizing unit and the fan through the control unit.

2. The nebulizing apparatus as described in claim 1, further comprising a first cover movably disposed on the top of the outer housing, a corner of the first cover tilting upward at an angle so that an opening is formed between the first cover and the outer housing to allow the nebulized particles to be dispersed outside of the outer housing through the opening, the nebulized particles dispersed on the inner side of the first cover being condensed to form a condensed liquid, the condensed liquid returning to the reservoir along the inner side of the first cover.

3. The nebulizing apparatus as described in claim 2, wherein the reservoir comprises:
an outer cup disposed in the accommodation space;
an inner cup disposed in the outer cup;
a first filtering unit disposed on the bottom of the inner cup; and
a driving unit disposed on the bottom of the outer cup;
wherein the outer cup communicates with the inner cup, the condensed liquid return to the inner cup along the inner side of the first cover and then return to the outer cup after the impurities are filtered by the first filtering unit, and the driving unit pumps the solution in the outer cup into the nebulizing unit.

4. The nebulizing apparatus as described in claim 3, wherein the reservoir further comprises a second filtering unit disposed on the bottom of the inner cup and wherein the condensed liquid return to the inner cup along the inner side of the first cover after the impurities are filtered by the second filtering unit.

5. The nebulizing apparatus as described in claim 4, wherein the materials of the first filtering unit and the second filtering unit are filter screens, porphyries andesite, filter cartridges, carbon filter layers or organic foams.

6. The nebulizing apparatus as described in claim 3, wherein the materials of the inner cup, the outer cup and the outer housing are plastics or metals.

7. The nebulizing apparatus as described in claim 3, wherein the nebulizing unit comprises:
a fixed base disposed between the inner cup and the outer cup and connected to the inner cup;
a liquid conduit disposed on one side of the fixed base, one end of the liquid conduit being connected with the driving unit for receiving the solution pumped by the driving unit; and
a nebulizing module disposed on the fixed base at the position adjacent to the liquid conduit, the solution pumped by the driving unit forming a curved liquid film in the gap and being adsorbed on the nebulizing module.

8. The nebulizing apparatus as described in claim 7, wherein the nebulizing module comprises:
a piezoelectric drive element disposed on the fixed base; and
an nebulizing plate connected to the piezoelectric drive element and provided with a plurality of millipores, the nebulizing plate being spaced apart from the other end of the liquid conduit at the gap, the nebulizing plate being vibrated by the piezoelectric drive element, so that the plurality of millipores of the nebulizing plate nebulize the curved liquid film to generate the nebulized particles.

9. The nebulizing apparatus as described in claim 1, wherein the power supply unit is a battery case and wherein a second cover is disposed on the outer housing at the position corresponding to the battery case and movably covers the outer housing.

10. The nebulizing apparatus as described in claim 1, wherein a multicolor light-emitting element is disposed at the center of the chassis and connected with the control unit, the control unit controls each of the color and flicker frequency of the multicolor light-emitting element, and each of the color and flicker frequency of the multicolor light-emitting element indicates a mode of operation of the nebulizing apparatus.

11. The nebulizing apparatus as described in claim 1, further comprising an external power unit connected with the control unit.

12. The nebulizing apparatus as described in claim 11, wherein the external power unit is a 110 to 240 volt AC power line or a 5 volt DC power line.

13. The nebulizing apparatus as described in claim 1, wherein the solution is water, a drug solution, aromatic essential oil, or a mixed solution thereof.

14. The nebulizing apparatus as described in claim 1, wherein the surface of the outer housing is provided with a plurality of hollowed out holes.
